(19) United States
(12) Patent Application Publication
(10) Pub. No.: US 2014/0310461 A1
(43) Pub. Date: Oct. 16, 2014

(54) OPTIMIZED AND PARALLEL PROCESSING METHODS WITH APPLICATION TO QUERY EVALUATION

(71) Applicant: SpeedTrack, Inc., Yorba Linda, CA (US)

(72) Inventors: Krzysztof Lukasz Mazur, Krakow (PL); Jerzy Josef Lewak, Del Mar, CA (US)

(73) Assignee: SpeedTrack, Inc., Yorba Linda, CA (US)

(21) Appl. No.: 14/252,660

(22) Filed: Apr. 14, 2014

Related U.S. Application Data
(60) Provisional application No. 61/811,212, filed on Apr. 12, 2013.

(51) Int. Cl. G06F 12/08

(52) U.S. Cl. CPC G06F 12/0842
USPC 711/118

(57) ABSTRACT

Methods of computing the results of logical operations on large sets are described which coax a processor to utilize efficiently processor caches and thereby reduce the latency of the results. The methods are particularly useful in parallel processing systems. Such computations can improve the evaluation of queries, particularly queries in faceted navigation and TIE systems.

### CROSS REFERENCE TO RELATED APPLICATIONS

This application claims the benefit of the filing of U.S. Provisional Patent Application No. 61/811,212, filed on Apr. 12, 2013, the disclosure of which is incorporated by reference herein.

### BACKGROUND OF THE INVENTION

The present invention relates generally to database operations, and more particularly to database query evaluations.

The determination of unions, intersections, and other logical operations on very large sets of any entities is a common computational procedure, generally highly demanding of resources. One application of this procedure is in computer executed searches of structured and unstructured data, indexed for fast search using vector array structures equivalent to a matrix of associations between search entities and search terms. Entities can be any identifiable data or data part. For example, in search applications, entities can be field values, words, characters, numbers, records, or any identifiable part of the data.

### BRIEF SUMMARY OF THE INVENTION

Time to perform queries involving a large number of entities and search terms can be minimized in two ways. Program code may be written in a way that utilizes processor caches optimally. That the cache-friendly method. Second, a query using parallel processes. Both methods may be used when resources permit.

Aspects of this invention relate to methods of computing the result of any Boolean query comprised of such vectors, for either simple or counting applications, using methods to reduce query latency by enabling the processor to use effectively its processor caches and to use parallel processes more efficiently. The discussion will be in terms of methods for the disjunction of item vectors, but a practitioner of ordinary skill will be able to apply similar methods to any Boolean operations on vectors.

In one aspect of the invention a method of using a computer processor core in a computer to compute a result set of identifiers of data components, logically derived from a plurality of sets of data component identifiers and Boolean operators comprises a query matching data items, said method comprising: creating a plurality of buffers storing elements of data components for the purpose of optimizing data conveyance to the processor core; and adjusting size of the buffers so they fit into the fastest processor cache; performing logical evaluations implied by the Boolean operators using the buffers.

In another aspect of the invention is a method of instructing a computer processor core in a computer to determine a result set of element identifiers, logically derived from a plurality of data element identifiers and Boolean operators, said method comprises: using buffer sizes which fit into a computer processor cache enabling the processor to determine the result set of identifiers with the minimum number of operations; and using available multiple processor cores for evaluation of Boolean operations.

In another aspect of the invention a method of using a computer processor core in a computer comprises; determining items matching a query comprised of selectors and Boolean operators and determining a count of the items matching the query and associated with a selector identifier by using buffers of a size so that one or more will fit into a low-level processor cache, to temporarily store subsets of selector identifiers associated with each item.

In another aspect of the invention a method of using a plurality of computer processor cores to compute a result set of selector identifiers, logically derived from a plurality of sets of selector identifiers, said method comprises: dividing each of the plurality of sets into subsets; and computing the contribution of each subset to the result set using a plurality of processor cores; and combining the results from the plurality of processor cores.

These and other aspects of the invention are more fully comprehended upon review of this disclosure.

### BRIEF DESCRIPTION OF THE FIGURES

FIG. 1 shows a flow diagram of a process in accordance with aspects of the invention.

### DETAILED DESCRIPTION

In indexed searches, one form of an index uses association between search terms, referred to as selectors, and search elements of data, referred to as items. Associations between selectors and items can be visualized as a bit association matrix, or table, in which each row represents an item and each column a selector. Each non-zero cell represents association between the corresponding row (item) and column (selector), whereas the zero cells represent no association between the corresponding item and selector. Each row of this matrix we will refer to as an item row. Similarly columns of the matrix will be referred to as selector column.

One implementation of an association matrix is an array of association item vectors, each vector representing an item row of the matrix, its components being the identifiers of the associated selectors. These identifiers can be the column numbers of the non-zero elements in the matrix. We call this the item vector ID representation. An alternative representation of each matrix row is as a bit vector which is the item row of the matrix.

Another implementation of the matrix is an array of association selector vectors, each vector representing a selector column of the matrix, its components being the identifiers of the associated items. These identifiers can be the row numbers of the non-zero elements in the matrix. We call this the selector vector ID representation. An alternative representation of each matrix row is as a bit vector which is the selector column of the matrix.

Certain types of searches, to achieve faster response times use both types of matrix implementations.

A selector is any part of data in a database which may need to be used as a search term, or part of a search term. Which parts of data are chosen as selectors and which parts as items depends on the particular data types and the preferred manner of indexing when creating the association vectors. For example, if items are records, then selectors could be field values, words in field values, numbers, or even individual characters in field value. If items are chosen to be field values or words in field values, selectors could be individual characters, position dependent or independent.

Evaluating queries in indexed data often determines intersection and union sets of the components of such association vectors. The intersection of the components of two selector vectors is a result vector whose components are the identifiers of items matching the query consisting of the conjunction of the two selectors. The union of the components of two item vectors is a result vector whose components are the selectors associated with either of the two vectors, that is their disjunction.

Items matching a Boolean query comprised of selectors can be found by evaluating conjunctions and/or disjunctions of selector vectors. Determining selectors associated with a set of items means determining the disjunction of the item vectors in the set of items. In selector vectors the components are identifiers of items and in item vectors the components are the identifiers of the selectors.

In some applications, which will be referred to as simple applications of the association matrix, computations of query results uses the disjunction of a set of m vectors. The m vectors consist of a cumulative total of n components.

In other applications, which will be referred to as counting applications of the association matrix, computations of query results determine the number of items associated with each component in the result set of components.

When evaluating searches, conjunctions are usually only used between a relatively small number of vectors, but disjunctions are sometimes used between a very large number of vectors. In almost all cases the larger the number of vectors to be conjoined, the smaller the set of components of the resulting vector. In contrast, in almost all cases, the larger the number of vectors to be disjoined, the larger the number of components of the result vector. Therefore we describe here methods of evaluating such disjunctions because they are most likely to experience longer compute times. Conjunctions, exclusive disjunctions, and negations can also use these methods with modifications for the relevant logic operations. These methods may be applicable to all cases where logical set operations are needed, which may include cases other than the ones described here. These methods can be implemented in a computer system, or indeed in any electronic device using processors and a non-transitory means of storing data.

Sometimes the set of item vectors is very large, particularly when they result from a previous item search which happens to match a very large number of items. The set of selectors associated with the matching items, selectors which are available for use in subsequent narrowing searches, is obtained as the disjunction of the set of matching item vectors. This disjunction can be carried out using one of two different data structures for storing the vectors. Assuming that the vectors are ID vectors, one efficient structure for the result vector, in simple applications, is a bit vector which provides a way of performing a disjunction operation of adding the components of the ID vector to the output bit vector in O(n) time complexity, where n is the number of ID components of the ID vector to be added. This is possible because when creating the union of the components of the ID vector with the bit output vector, the vector component IDs immediately determine the bit location in the output bit vector which can then be set. This builds the union set efficiently.

Having to disjunctively combine a cumulative total of n components of m vectors an algorithm has to enumerate all the n components from all the vectors and use them to add components to the result vector, or counts to the counting vector.

The number of bits set in the result vector, when represented as a bit vector, is the count (size) of the union set of all the unique component selectors in the m vectors. In counting applications, the result vector can also use that same number of components, but each component is an integer count of the items associated with the selector (which means item vectors containing the selector as a component) and so the counting vector then not be a bit vector. When using the bit vector as a result vector for a simple application, or an array of counts for the counting application, an algorithm, referred to as the Base Algorithm, in summary outline, is as follows:

Base Algorithm:

1. For the next integer ID component of a vector in the set of vectors

2. If a simple application, use the integer ID as an index into the output bit vector, compute memory location address of the bit and set it, or if a counting application, use the integer ID to determine the array index in the counting array and increment the count at that index.

3. Repeat from the beginning until finished.

Such a simple algorithm has time complexity of order O(n). The steps involved are elementary and most CPUs are capable of performing them very fast provided that for the simple case all the bit values and for the counting case all the array elements can be accessed fast. This can be assumed to be fast if the result vector is small enough to fit into a low level cache of the CPU. When this is not possible, we describe next a two phase method which distributes or scatters the component IDs into a set of buffers, each buffer storing a range of IDs.

In some databases the union set of item vectors contains component associations to millions of selectors which means that the selector IDs have a big range of values. That in turn may require using large output bit vectors or large output counting arrays. In such cases an output vector will probably not fit into any of the CPU caches of most present day computers. Even if it fits into one, it would still be better to fit it into a smaller range so it can fit into a lower level cache, which in general is smaller because the general rule is that the smaller a cache the faster it operates, which is why CPUs have a hierarchy of caches instead one large cache or just one memory.

Computing a disjunction set, or a counting set of a large number of vectors, possibly associated with a large number of components, are the two important and processor intensive operations that can benefit most from the two phase algorithm and from parallel processing as described herein. The two phase method is often needed for a parallel processing algorithm to fully benefit from the faster processing by multiple CPUs, because the two phase method improves performance by relieving bottlenecks dues to shared caches and memory.

Processing a query, particularly a query relying on computations involving a large number of vectors, involves relatively simple processes, but a very large number of accesses to a large number of data elements. Consideration of some details of such computations shows limits on the use of parallel processing. Furthermore it shows that introducing buffers which hold smaller numbers of vector components of the vectors being processed, can achieve considerable improvement in performance. Such improvement is achieved because of the way processor caches are used by the processors to access data. Processor access to data in RAM is about 80 times slower than access to data in L1 cache. Therefore when a very large number of accesses is involved, it pays to arrange the high-level code in such a way that the processor will naturally process the data in the fastest level cache many times before the cached data needs to be evicted. In other words for improved performance we prefer to make our high-level code appropriately structured by using buffers as described.

When a frequently accessed data structure does not fit into a processor cache and the accesses to the structure are scattered over the whole data structure, then the processor cache cannot speed up data accesses. Instead most reads or writes involves access to RAM rather than processor cache. The recently accessed data is cached. However if it is not used for long because it gets replaced by a data from a different part of the data structure, the cache does not help. In such a case we say that the data access pattern is cache-unfriendly.

Exact behavior of accesses depends on the exact distribution (spatial locality) of data within the structure and exact sequences of accesses to that data (temporal locality) as well as on a number of other factors. Those are:

Cache size

Cache eviction/replacement algorithm

Cache line size (the smallest unit of cached memory)

We can optimize performance by arranging the buffer size to fit frequently accessed data into a CPU cache and by coaxing the eviction replacement algorithm to be used efficiently. Eviction efficiency can be achieved by ensuring almost all accesses to a cached line are completed before its eviction.

If cache issues are ignored then the components of an output vector will be accessed in a scattered manner (randomly). An output vector which is too large to fit in a processor cache when randomly accessed, will cause a degraded performance because different parts of it will be accessed in random order causing a large number of evictions. Therefore for optimum performance it is desirable to create a cache friendly environment as described here.

Example of a Two-Phase Algorithm

As an example, consider the computer implementation methods of two related computations. First the union of the sets of components of a set of vectors resulting in an output vector, and second, the count of the number of vectors contributing to each component in the union set, resulting in a counting output vector. These are quite general processes and so the described methods can be used in many possible applications. One example application is the determination of the frequencies, that is counts of items, associated with each selector in a TIE (Technology for Information Engineering) system.

Although the following implementation description is about the evaluation of the disjunction of the components of an item vector with an output vector, it will be recognized by a practitioner of ordinary skill that a very similar procedure can be used in any situation where any set operation (such as intersection, union, or complement) of multiple sets of elements is needed, or when counts of sets contributing to each element of the resulting set are needed.

The following describes one possible way of more optimally, in a cache friendly way, implementing in software, running on a computer system, the determination of the result set of the union of a number of component sets of elements and the counts of component sets contributing to each element in the resulting union set. It will be recognized by a practitioner of ordinary skill that there are several ways of arranging the listed steps to obtain the same or similar result. The detailed steps listed here are to be treated as examples of possible implementations of the described methods.

The methods can be described either in set operations on subsets of a master set of selector elements, or in Boolean operations on item vectors whose components are such selector subsets. Our descriptions of set operations are expressed in terms of Booleans of vectors whose components are the sets being operated on.

The two-phase algorithm uses a set of buffers. The number of buffers, N should be chosen so that the buffer access array (list), together with the current write locations of each buffer, fits into a low level cache, for example the L1 cache although other level caches can be used. If the chosen processor cache size is denoted by L bytes, and a cache line size is CL (the smallest unit of data the cache can maintain (load/evict)) separately (individually), then for N buffers we need 4N bytes for buffer access array and N*CL for the current write locations. That means that N=L/(4+CL) is the maximum number of buffers to fit frequently accessed data into the cache. Each element of the buffer access array (list) stores a pointer, or its equivalent, to the next element available for writing of the respective buffer.

Each buffer is described by its ID and by two other numbers: the number of elements it can hold n, that is its size, and the range, R of element IDs assigned to it. It is simplest to make each buffer range the same, although this is not necessary. Let the buffer number (zero based) be the buffer identifier and designate it as n_{b}. The first buffer (n_{b}=0) stores element IDs from 0 through R−1, the second stores IDs from R, through 2R−1, and so on. Given an element ID=the buffer number that should be used to store it is given by n_{b}=INT(i/R). However the high-level calculation of division to obtain n_{b} can be arranged to be replaced with a bit shift by making R a power of 2. For example, if R is made a power of 2, then addressing a buffer identifier index requires an appropriate number of bit shifts of the item component index i. If R=2^{d}, n_{b}=i shifted right by d bits. On computers using current popular processors this will execute considerably more quickly than the division combined with the INT instruction.

The following steps represent an example of one way of implementing the processing. The steps list the Scattering Phase interleaved with the Integrating Phase so during the processing a change to the Integrating Phase is indicated when a buffer is full, in step 0 and when the scattering phase is finished in step [0053]. The Integrating Phase steps are described separately.

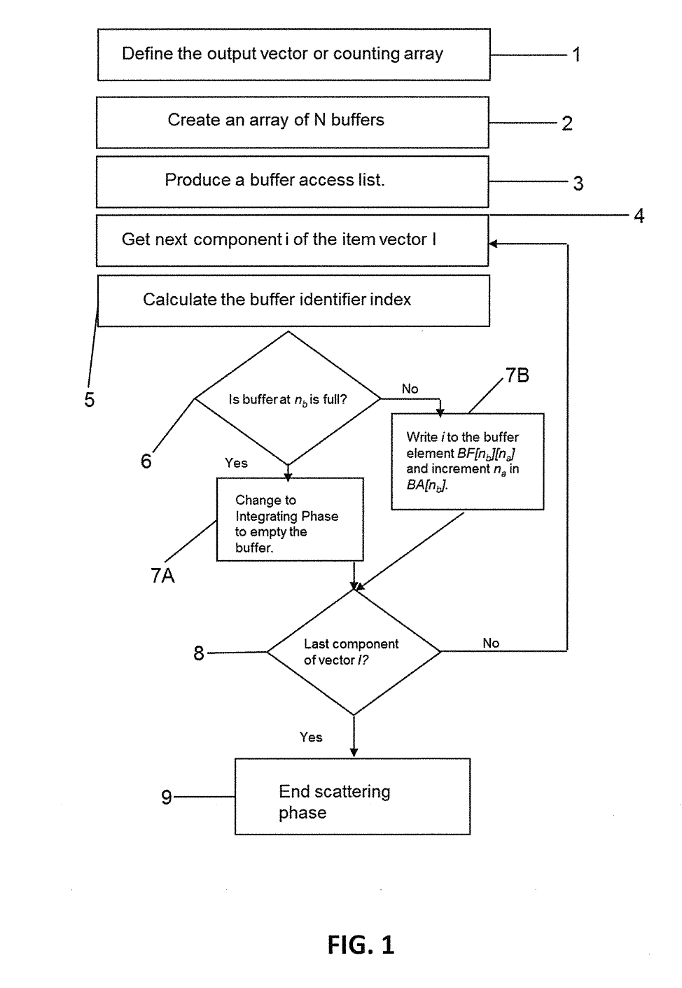

Scattering Phase as shown in FIG. 1.

1. Define the output vector or counting array of suitable size, such that the ID of every possible component is simply related to the array index (Block 1).

2. Create an array of N buffers, where each buffer is itself an array of n elements. Call the array BF[n_{b}][nₐ] where n_{b} is the buffer identifier index and nₐ is an index of a buffer array element (Block 2).

3. Produce a buffer access list of size N (let n_{b} be the identifier of each buffer) as an array BA[N] storing a pointer, or pointer equivalent, commonly nₐ, to the next buffer element available for writing in the respective buffer. So for example, if element BA[n_{b}]=nₐ, the next write to buffer n_{b} is to the element BF[n_{b}][nₐ] (Block 3).

4. For each item vector I do the following through step 0:
a. Get next component i of the item vector I (Block 4).
b. Calculate the buffer identifier index as n_{b}=INT(i/R) (Block 5)
c. Determine if the buffer at n_{b} is full (Block 6).
d. If buffer at n_{b} is not full, write i to the buffer element BF[n_{b}][nₐ] and increment nₐ in BA[n_{b}] (Block 7B).
e. If buffer is full, change to Integrating Phase to empty the buffer (Block 7A).
f. If not finished processing all vectors: next vector I. Return to Block 4 until all components of vector I have been processed (Block 8).

If any buffers remain not emptied, go to Integrating Phase to empty them (Block 7A).

End processing if all buffers have been emptied and no new processing remains (Block 9).

Integrating Phase

The following steps describe how to empty a buffer.

Starting with the first element of a buffer, iterate the following:
1. Take the next value from the buffer.
2. Use the value as an index into the bit or counter vector to compute memory location address of the bit or counter.
3. Set the bit or increment the counter.
4. If any components remain to be processed repeat from step 0.
5. When a buffer is empty, set the respective buffer access list element, BA[nₐ], to its starting value, commonly 0.
6. Return to the scattering phase.

The Integrating Phase does the same as the basic algorithm. It has to use the components to set the same bits or increase the same counters as in the basic algorithm. The only difference is that the source of components is a buffer. Each entry coming from the same buffer belongs to a narrow range of values because the scattering phase (step A) distributes components to different buffers based on the range of the component indexes that fit into the respective subrange.

Having a long sequence of components fitting a narrow range of values (which is what happens during the integrating phase of the two phase algorithm) dramatically increases memory access locality because all the bits or counters accessed are close to each other. This means that a single cache line contains multiple counters accessed in this phase. Furthermore, there is a much higher chance a counter is increased twice or more before the cache line storing its data has to be flushed in favor of another piece of memory storing a different set of counters.

Parallel Processing

Memory synchronization issues arise when multiple threads are involved in computations. For the base algorithm good performance results can be achieved by using separate result vectors for each thread and then combining them after all the processing is done. This prevents any synchronization issues and is fast when each of the threads is performed on a separate core with a dedicated cache and its result vector fits into the cache (optimal case). The worst case scenario (large result vectors) should not be multithreaded when using the base algorithm, because the bottleneck is memory access.

Separate parallel processes, or threads can be used to evaluate large vector disjunctions and provide a faster response time. In current hardware, when using multiple parallel processing systems, memory access pattern becomes even more important as memory controller and busses are shared between multiple processors. This means that the transfer rate of data from RAM to processor cache could become a limit on the number of effective parallel processes on a single computer. Adding a parallel process beyond that limit would not improve performance. However, parallel processing can also be performed on multiple computers and adding more computers can improve performance.

One method of parallel processing divides a set of N vectors into n separate subsets of vectors. When n processes are available, each subset of approximately N/n vectors can be evaluated in a separate process, producing n separate result vectors which can then be combined, usually in a single process. A small disadvantage of this method is the fact that the last step of combining the output vectors is usually evaluated in a single process.

This disadvantage can be mitigated when the two phase algorithm is used. For the integrating phase the result vector can be shared between the threads, with multiple threads simultaneously writing to its different parts. Each part relates to a range of selectors also being the range of a single buffer. Such result vector sharing may be accomplished by locking the parts of the result vector independently and then unlocking it when the buffer is empty. Each part of the vector has its own lock. The locking is performed when a thread runs out of free space in a buffer and switches to the integration phase to flush the content of the buffer and write to the range of components of the result vector within the range of the buffer. After the buffer is flushed the range of components of the result vector can be unlocked and the thread can return from the integration phase to the scattering phase of the buffer. Assuming the number of buffers (selector ranges) is greater than the number of threads, this locking scheme provides very little congestion on a single lock, thus providing good performance of each thread.

This division of a large number of vectors to be processed can also be performed dynamically, during processing. For example each of the processes can fetch a number of vectors to be assigned to it for the processing, whenever it runs out of vectors to be processed. The process stops when all the processes finish and there are no vectors left in the global set of vectors to be assigned to parallel processes. In this way all the processes (threads) are busy and thus contribute to the overall increase of performance for almost all the processing time. Such a dynamic division (or task distribution/allocation) provides load balancing.

Another example of a partitioning method divides each of the vectors to be disjunctively combined, into a number of sub-vectors and then processes each set of sub-vectors in separate processes. However, this method of dividing the task may be useful only in applications where the average number of vector components per vector is large. In many applications where the vectors are item vectors, the average number of vector components per vector is relatively small and so this method is probably not worth using. When used, each sub-vector can be partitioned from the main vector by defining a range of component IDs for the sub-vector. Such a partition of each vector can be most efficiently performed when the vector components are sorted according to their IDs. A disadvantage of this method is the inability to balance the number of components to be processed by each process making it more likely that the processing time is different in each separate process.

GPU Issues

GPUs contain a large number of processors, so it may be beneficial to use parallel processes with the two phase algorithm. Depending on the exact sizes of internal memories and number of processing units on the GPU, a variation of the algorithm may be used to fit into internal memory in a cache friendly way, a single part of the output vector used for the integrating phase. For example, two or more scattering phases using a hierarchy of buffers could be used and arranged so that each higher level buffer writes to a child buffer with a smaller range, which then writes to another child buffer, or if it is the lowest level buffer and is full, is flushed into the output vector in an integrating phase.

Although the invention has been discussed with respect to various embodiments, it should be recognized that the invention comprises the novel and non-obvious claims supported by this disclosure.

What is claimed is:

1. A method of using a computer processor core in a computer to compute a result set of identifiers of data components, logically derived from a plurality of sets of data component identifiers and Boolean operators comprising a query matching data items, said method comprising:
creating a plurality of buffers storing elements of data components for the purpose of optimizing data conveyance to the processor core;
adjusting size of the buffers so they fit into the fastest processor cache;
performing logical evaluations implied by the Boolean operators using the buffers.

2. The method of claim 1 wherein a buffer access list is used for access to a buffer.

3. The method of claim 2 wherein a number of elements in the buffer access list is chosen so that the buffer access list and current write locations will fit into a low-level cache.

4. The method of claim 1 wherein the computer processor core is one of a plurality of processor cores performing parallel processing to compute a result set.

5. The method of claim 4 wherein the number of buffers, accessible through the buffer access list, is chosen so that the buffer access list and the current write locations will fit into a low-level cache.

6. A method of instructing a computer processor core in a computer to determine a result set of element identifiers, logically derived from a plurality of data element identifiers and Boolean operators, said method comprising:
using buffer sizes which fit into a computer processor cache enabling the processor to determine the result set of identifiers with the minimum number of operations;
using available multiple processor cores for evaluation of Boolean operations.

7. The method of claim 6 wherein the set of element identifiers and the Boolean operators is partitioned into subsets.

8. The method of claim 6 wherein a task of determining a result set is partitioned between the processor cores.

9. The method of claim 7 wherein a plurality of the subsets are each used by a processor core in determining the result set.

10. The method of claim 7 wherein each set of the plurality of sets of element identifiers is represented as a vector whose components are element identifiers.

11. The methods of claim 10 wherein the result set of element identifiers is stored as a result vector.

12. A method of using a computer processor core in a computer comprising:
determining items matching a query comprised of selectors and Boolean operators;
determining a count of the items matching the query and associated with a selector identifier by using buffers of a size so that one or more will fit into a low-level processor cache, to temporarily store subsets of selector identifiers associated with each item.

13. The method of claim 12 wherein each buffer stores a range of the selector identifiers.

14. The method of claim 13 wherein a buffer access list is used for access to a buffer selector identifier.

15. The method of claim 14 wherein the number of selector identifiers in the buffer access list is chosen so that the buffer access list will fit into a low-level cache.

16. The method of claim 12 wherein the computer processor core is one of a plurality of processor cores performing parallel processing to compute the result set.

17. The method of claim 15 wherein the range of the number of selector identifiers in the buffer is made a power of 2.

18. The method of claim 16 wherein each set of a plurality of sets of selector identifiers is represented as a vector whose components are selector identifiers.

19. A method of using a plurality of computer processor cores to compute a result set of selector identifiers, logically derived from a plurality of sets of selector identifiers, said method comprising:
dividing each of the plurality of sets into subsets;
computing the contribution of each subset to the result set using a plurality of processor cores;
combining the results from the plurality of processor cores.
